(19) United States
(12) Patent Application Publication
(10) Pub. No.: US 2018/0203827 A1
(43) Pub. Date: Jul. 19, 2018

(54) LIGHTWEIGHT TRACKING OF SUBSTITUTED CHARACTERS IN TEXT FIELDS

(71) Applicant: International Business Machines Corporation, Armonk, NY (US)

(72) Inventors: Daniel P. Craggs, Montreal (CA); Jeremiah S. Swan, Stouffville (CA)

(21) Appl. No.: 15/406,939

(22) Filed: Jan. 16, 2017

(51) Int. Cl. G06F 17/22; G06F 17/24

(52) U.S. Cl. CPC G06F 17/22; G06F 17/24

(57) ABSTRACT

An aspect includes initializing a character substitution binding by passing to the character substitution binding an un-substituted raw string, a description of characters that should be substituted, and a character to be used for substitution. A new substituted display string that includes the character to be used for substitution in place of any characters in the raw string that fit the description of characters that should be substituted is received from the character substitution binding and output to a display. The raw string is updated to reflect a detected request change entered by a user. The updated raw string is passed to the character substation binding. An updated display string is received from the character substitution binding and it includes the character to be used for substitution in place of any characters in the updated raw string that fit the description of characters that should be substituted.

### BACKGROUND

The present invention relates to computer software, and more specifically, to lightweight tracking of substituted characters in text fields via a character substitution binding.

There are times in the software development process when it is helpful to replace control characters in a file with a substitute character before displaying contents of the file, particularly when control characters have zero width and can appear misleading and confusing to users. However, the use of substitute characters can cause issues when the user is able to edit this text field, as the user can overwrite substituted characters and also input the same value as the character used for substitution (e.g., a period is often used as the substitute character).

### SUMMARY

Embodiments include a method, system, and computer program product for lightweight tracking of substituted characters in text fields via a character substitution binding. A method includes initializing a character substitution binding by passing to the character substitution binding an un-substituted raw string, a description of characters that should be substituted (where “substituted” is used here in the sense of “replaced”), and a character to be used for substitution. A new substituted display string that includes the character to be used for substitution in place of any characters in the raw string that fit the description of characters that should be substituted is received from the character substitution binding. The display string is output to a display of a user device. A requested change, entered by a user at the user device, to the display string is detected, and the raw string is updated to reflect the detected requested change. The updated raw string is passed to the character substation binding. An updated display string is received from the character substitution binding and it includes the character to be used for substitution in place of any characters in the updated raw string that fit the description of characters that should be substituted. The substituted display string is output to the display of the user device.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a flow diagram of a process for performing lightweight tracking of substituted characters in text fields via a character substitution binding;

FIG. 2 illustrates an example of performing lightweight tracking of substituted characters in text fields via a character substitution binding; and

FIG. 3 illustrates a computer system for performing lightweight tracking of substituted characters in text fields via a character substitution binding in accordance with one or more embodiments.

### DETAILED DESCRIPTION

Embodiments described herein include lightweight tracking of substituted characters in text fields via a character substitution binding. The character substitution binding can keep track of an unsubstituted version of a string of characters or integers so that whatever a user does to interact with the text field, the user will not lose information about the substituted characters.

In accordance with one more embodiments, the character substitution binding keeps a record of the unsubstituted value and updates it each time the value changes in order to keep track of the substituted characters. A programmer can add this this feature by supplying three pieces of information per requested change (or update): the number of characters selected immediately before an update; the caret position after the update; and the value of the character field after the update. Once this information is supplied, the updated raw value can be returned to the programmer to use as the ‘real’ value and not the value displayed on the screen. The programmer can easily create a substituted character binding for their character field and keep track of the substitutions without having to add any complex mappings or address each memory byte. One or more embodiments described herein can be implemented across existing text fields and supports users copying and pasting text into the text fields, highlighting characters in the text field and typing over them. Characters that are input can be substituted with displayable characters while the user is inputting data so that the user never sees the raw value. The embodiments described here can exist completely on the front end so it doesn't interfere with features such as bi-directional (BIDI) support or other complex features that may be implemented.

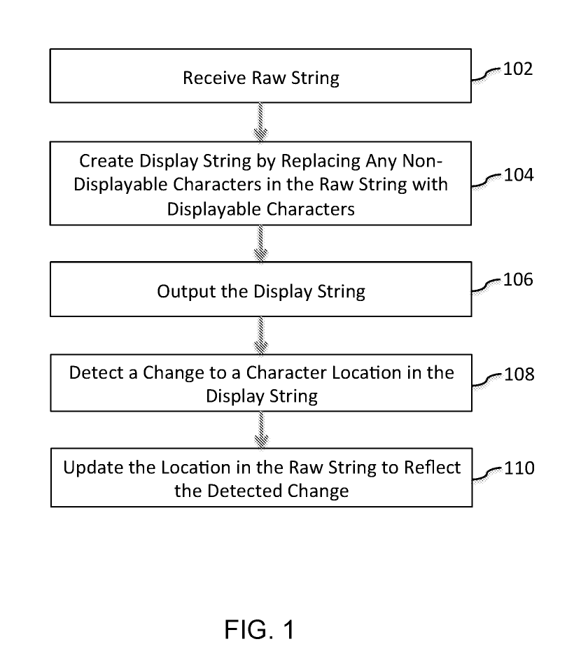

Turning now to FIG. 1, a flow diagram of a process 100 for performing lightweight tracking of substituted characters in text fields via a character substitution binding is generally shown in accordance with one or more embodiments. As used herein, the term “binding” refers to a mapping between a substituted character in a display string and its corresponding unsubstituted character in a raw string. In accordance with one or more embodiments, the character substitution binding is initialized by passing it the raw unsubstituted string, a regular expression for the characters that should be substituted, and a character to be used for substitution (e.g., a period or “.”). The binding will then supply the new substituted string that can be used as the display string. Immediately before any update, the number of characters selected or highlighted is set, or selected. Immediately after a change, the binding is notified of an update with the caret position information and the new value present in the character field. In accordance with one or more embodiments, the binding uses this information to update the raw unsubstituted value and to update the substituted value (replacing any characters that are candidates for substitution in the process of doing so). At any time, the binding can be called upon to retrieve the raw unsubstituted value and the substituted value.

At block 102 of FIG. 1, an initial raw string is received, and at block 104, a display string is created. In accordance with one or more embodiments, the character substitution binding is initialized at block 104 by providing it with the initial raw unsubstituted value, the substitution character and the characters that are to be substituted. In accordance with one or more embodiments, the initialization can be implemented by the following Java® code:

public CharacterSubstitutionBinding (String rawText, String

substitutionCharacter, String characterToBeSubstituted) {

fSubstitutedText = rawText.replaceAll(fCharacterToBeSubstituted,

fSubstitutionCharacter);

fRawText = rawText;
fSubstitutionCharacter = substitutionCharacter;
fCharacterToBeSubstituted = characterToBeSubstituted;
fOriginalText = fSubstitutedText;
}

At bock 106, the fSubstitutedText (also referred to herein as the “display string”) is output, for example to a user display device. The display string is of the same length as the frawText (also referred to herein as the “raw string”) and has a substitutionCharacter in place of any CharacterToBeSubstituted in the raw string. In one or more embodiments, the substitutionCharacter is a non-displayable character such as a null character or an escape character and the CharacterToBeSubstituted is a displayable character such as a period.

Blocks 108 and 110 describe processing that can occur when a change to the display string is detected. In accordance with one or more embodiments, binding is performed for just locations impacted in response to each change from the user that is detected. In accordance with one or more embodiments, the user is using text editing software to update the display string, and the detection of changes is performed by a text editing software framework such as Eclipse® Standard Widget Toolkit (SWT) or Java Abstract Window Toolkit (AWT) which can be used with the binding techniques described herein. These frameworks can be used to build graphical user interfaces (GUIs) where the character binding can be used on the appropriate text fields within the user interface.

“org.eclipse.swt.widgets.Text” and “java.awt.TextArea” are two low-level text editing components provided by the SWT framework and the AWT framework, respectively, that are often used to display textual data and obtain textual input from users. The programming interfaces provided for the text field implementations within each of these frameworks provides methods to listen for text changes from the user (the ModifyListener and TextListener, respectively) and ways to obtain the cursor position and text details (the getCaretPosition( ) , getSelectionText( ).length( )/getSelectedText( ).length( ) and getText( ) methods on the respective text field widgets).

In embodiments were the text editing software framework is SWT, the following code can be utilized:

final org.eclipse.swt.widgets.Text swt_text_field = new

org.eclipse.swt.widgets.Text(parent, style);

swt_text_field.addModifyListener(new ModifyListener( ) {

@Override

public void modifyText(ModifyEvent arg0) {

//text has been modified by the user, so obtain the information needed to
update the character binding

int caretPosition = swt_text_field.getCaretPosition( );
int selectedTextLength =
swt_text_field.getSelectionText( ).length( );
String newText = swt_text_field.getText( );

//and then trigger the character substitution binding to update the raw and
displayable strings

binding.updateRawText(newText, caretPosition, selectedTextLength);
}
});

In embodiments were the text editing software framework is AWT, the following code can be utilized:

final java.awt.TextArea awt_text_field = new Java.awt.TextArea( );
awt_text_field.addTextListener(new TextListener( ) {

@Override

public void textValueChanged(TextEvent e) {

//text has been modified by the user, so obtain the information needed to
update the character binding

int caretPosition = awt_text_field.getCaretPosition( );
int selectedTextLength = swt_text_field.getSelectedText( ).length( );
String newText = awt_text_field.getText( );

//and then trigger the character substitution binding to update the raw and
displayable strings

binding.updateRawText(newText, caretPosition,
selectedTextLength);
}
});

Inputs to the character substitution binder when a change is detected can include: the highlighted text in the field immediately before the change from the user; the value of the text field immediately after the change from the user; and the caret position of the text field immediately after the change from the user. A change can include overwriting a character(s) with a new character(s), inserting a character(s), and deleting a character(s). In accordance with one or more embodiments, blocks 108 and 110 can be performed to determine the new value of the raw unsubstituted value using the Java code shown below:

public String updateRawText(String newText, int caretPosition, int

selectedTextLength) {

fSubstitutedText = newText;
int numOfCharsInserted = newText.length( ) −

fOriginalTextlength( ) + selectedTextLength;

if (numOfCharsInserted < 0) {
int numberOfCharactersDeleted = fOriginalTextlength( ) -

fSubstitutedText.length( );

fRawText = fRawText.substring(0, caretPosition) + fRawText

.substring(caretPosition + numberOfCharactersDeleted,
fRawTextlength( ));

} else {
String prefix = newText.substring(0, caretPosition −

numOfCharsInserted);

String suffix = newText.substring(caretPosition, newText

.length( ));

int suffixPosn = fOriginalText.lastIndexOf(suffix, caretPosition

− numOfCharsInserted + selectedTextLength);

String insertedString = newText.substring(prefix.length( ),

newText.length( ) − suffix.length( ));

fRawText = fRawText.substring(0, prefix.length( )) +

insertedString + fRawText.substring(suffixPosn, suffixPosn +
suffix.length( ));}

String substitutedString = fSubstitutedText.replaceAll(

fCharacterToBeSubstituted, fSubstitutionCharacter);

// Reset original text
fOriginalText = substitutedString;
return fRawText;

}

Once the binding has returned fRawText the programmer can use this to make sure that this is the true value that is sent to the back end (e.g., data input for a program) while only displaying fSubstitutedText to the user. In accordance with one or more embodiments, any characters that should be substituted that are input by the user are instantly substituted before the user sees their raw representation. By storing fSubstitutedText (the display string) and fRawText (the raw string), the binding can provide the current state of the both the substituted version of the text field, and the unsubstituted version.

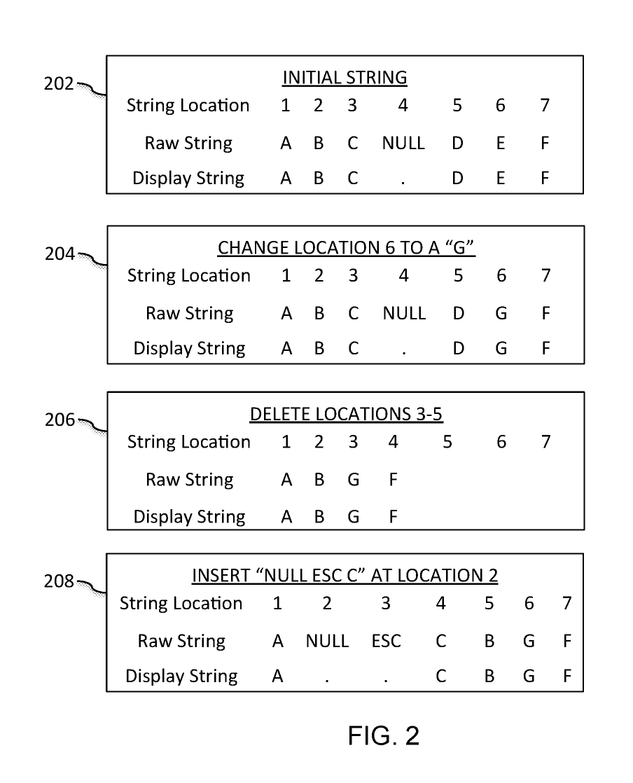

Turning now to FIG. 2, an example 200 of performing lightweight tracking of substituted characters in text fields via a character substitution binding is generally shown in accordance with one or more embodiments. Block 202 includes an initial string that includes one non-displayable control character, “null” at location 4 in the raw string. The null value at string location 4 is changed to a period (i.e., a period is substituted for the null), which is a displayable character, in the display string shown in block 202 of FIG. 2. The display string is output to a user for viewing and/or editing.

Block 204 shows the results of the user (e.g., using a text editor via a user input device and a display) overwriting the value in location 6 of the display string with a “G.” In response to detecting the change to location 6 of the display string, both the raw string and the display string are updated. Because “G” is a displayable character, a “G” is written to location 6 in both the raw string and the display string.

Block 206 shows the results of the user (e.g., using a text editor via a user input device and a display) deleting the values in locations 3-5 of the display string. In response to detecting the deletion of locations 3-5 in the display string, locations 3-5 are deleted in both the raw string and the display string.

Block 208 shows the results of the user (e.g., using a text editor via a user input device and a display) inserting three characters, “null escape C”, starting at location 2 of the display string. In response to detecting the insertion of the 3 characters starting at location 2 in the display string, all of the characters including the non-displayable characters are added to the raw string. Also in response to detecting the insertion of the 3 characters starting at location 2 in the display string, the null value at string location 2 is changed to a period, and the escape character at location 3 is changed to a period in the display string. In one or more embodiments, the substituting of a displayable character (e.g., a period) for a non-displayable character (e.g., an escape) is performed prior to the display string being output, or displayed to, the user.

In one or more embodiments, different displayable characters are used as substitution characters for different substituted characters. Thus, a period may be used as a substitution character for the null character and an explanation point used as a substitution character for the escape character.

As described herein, in accordance with one or more embodiments, just the locations in the display string and the raw string that are impacted by a change are modified by the binding process. This can result in processor and time savings by avoiding having to rewrite of every character in a long display string or raw string every time that an edit is received.

One or more embodiments of the character substitution binding described herein is utilized by debugging or testing software to modify data being used for testing. The display string and raw string may include the value of a variable used by a program, and the value of the variable is edited as described herein to test various aspects of the program. The raw string is sent to the program as the test data.

The characters being substituted, or modified in the display string, are not limited to non-displayable characters as they can be any characters that are restricted from being displayed to the user doing the text editing.

One or more embodiments include a process for lightweight tracking of substituted characters in text fields via a character substitution binding. As described herein, in accordance with one or more embodiments, the binding process includes initializing the character substitution binding by passing to the character substitution binding a raw un-substituted string, a regular expression for the characters that should be substituted, and a character to be used for substitution. A new substituted string is returned as output from the character substitution binding. On each and every change from a user, the character substitution binding is updated. The values input to each update can include: highlighted text in a field immediately before the change from the user; a value of a text field immediately after the change from the user; and a caret position (e.g., based on mouse location, or other indicator of position) of the text field immediately after the change from the user. The raw un-substituted value is updated and the substituted value is updated by the character substitution binding, which includes replacing any characters that are candidates for substitution. At any time, the character substitution binding can be called upon to retrieve the raw un-substituted value and the corresponding substituted value. Once the character substitution binding has returned a value of raw text, a programmer can use the value to ensure this is a true value that is sent to a backend while only displaying a substituted text to the use. Any characters that should be substituted, that are input by the user, can be instantly substituted before the user sees a respective raw representation. Storing the substituted text and the raw text allow the character substitution binding to provide a current state of a substituted version of a text field and an un-substituted version of the text field.

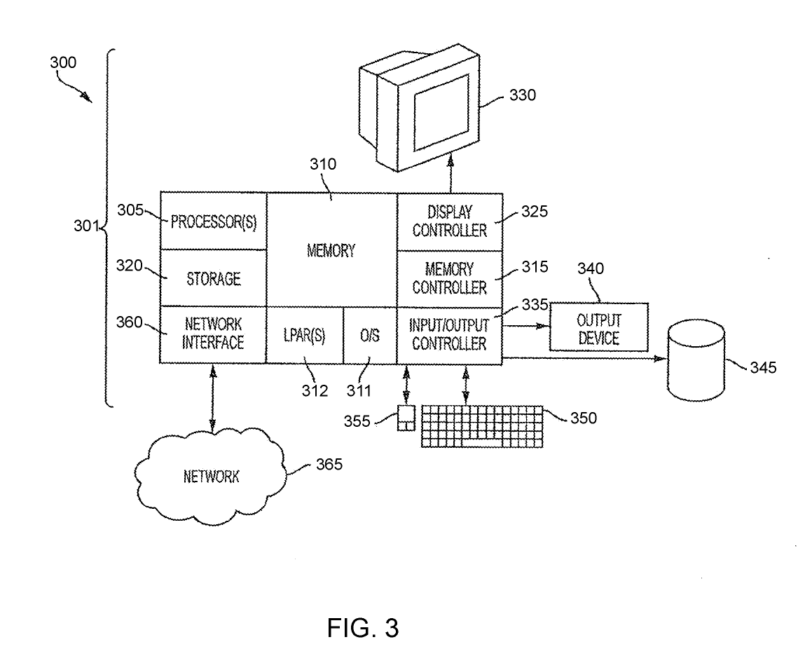

Turning now to FIG. 3, a computer system for performing lightweight tracking of substituted characters in text fields via a character substitution binding is generally shown in accordance with one or more embodiments. The methods described herein can be implemented in hardware, software (e.g., firmware), or a combination thereof. In an exemplary embodiment, the methods described herein are implemented in hardware as part of the microprocessor of a special or general-purpose digital computer, such as a personal computer, workstation, minicomputer, or mainframe computer. The system 300 therefore may include general-purpose computer or mainframe 301 capable of running multiple instances of an O/S simultaneously. One or more embodiments described herein can be implemented by a user device that includes all or a portion of the elements of the computer system 300 shown in FIG. 3.

In an exemplary embodiment, in terms of hardware architecture, as shown in FIG. 3, the computer 301 includes one or more processors 305, memory 310 coupled to a memory controller 315, and one or more input and/or output (I/O) devices 340, 345 (or peripherals) that are communicatively coupled via a local input/output controller 335. The input/output controller 335 can be, for example but not limited to, one or more buses or other wired or wireless connections, as is known in the art. The input/output controller 335 may have additional elements, which are omitted for simplicity, such as controllers, buffers (caches), drivers, repeaters, and receivers, to enable communications. Further, the local interface may include address, control, and/or data connections to enable appropriate communications among the aforementioned components. The input/output controller 335 may include a plurality of sub-channels configured to access the output devices 340 and 345. The sub-channels may include fiber-optic communications ports.

The processor 305 is a hardware device for executing software, particularly that stored in storage 320, such as cache storage, or memory 310. The processor 305 can be any custom made or commercially available processor, a central processing unit (CPU), an auxiliary processor among several processors associated with the computer 301, a semiconductor based microprocessor (in the form of a microchip or chip set), a macroprocessor, or generally any device for executing instructions.

The memory 310 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 310 may incorporate electronic, magnetic, optical, and/or other types of storage media. Note that the memory 310 can have a distributed architecture, where various components are situated remote from one another, but can be accessed by the processor 305.

The instructions in memory 310 may include one or more separate programs, each of which comprises an ordered listing of executable instructions for implementing logical functions. In the example of FIG. 3, the instructions in the memory 310 a suitable operating system (OS) 311. The operating system 311 essentially controls the execution of other computer programs and provides scheduling, input-output control, file and data management, memory management, and communication control and related services.

The memory 310 may include multiple logical partitions (LPARs) 312, each running an instance of an operating system. The LPARs 312 may be managed by a hypervisor, which may be a program stored in memory 310 and executed by the processor 305.

In an exemplary embodiment, a conventional keyboard 350 and mouse 355 can be coupled to the input/output controller 335. Other output devices such as the I/O devices 340, 345 may include input devices, for example but not limited to a printer, a scanner, microphone, and the like. Finally, the I/O devices 340, 345 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 300 can further include a display controller 325 coupled to a display 330. In an exemplary embodiment, the system 300 can further include a network interface 360 for coupling to a network 365. The network 365 can be an IP-based network for communication between the computer 301 and any external server, client and the like via a broadband connection. The network 365 transmits and receives data between the computer 301 and external systems. In an exemplary embodiment, network 365 can be a managed IP network administered by a service provider. The network 365 may be implemented in a wireless fashion, e.g., using wireless protocols and technologies, such as WiFi, WiMax, etc. The network 365 can also be a packet-switched network such as a local area network, wide area network, metropolitan area network, Internet network, or other similar type of network environment. The network 365 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 301 is a PC, workstation, intelligent device or the like, the instructions in the memory 310 may further include a basic input output system (BIOS) (omitted for simplicity). The BIOS is a set of essential software routines that initialize and test hardware at startup, start the OS 311, and support the transfer of data among the hardware devices. The BIOS is stored in ROM so that the BIOS can be executed when the computer 301 is activated.

When the computer 301 is in operation, the processor 305 is configured to execute instructions stored within the memory 310, to communicate data to and from the memory 310, and to generally control operations of the computer 301 pursuant to the instructions.

In an exemplary embodiment, the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method comprising:
initializing a character substitution binding by passing to the character substitution binding an un-substituted raw string, a description of characters that should be substituted, and a character to be used for substitution;
receiving, from the character substitution binding, a new substituted display string that includes the character to be used for substitution in place of any characters in the raw string that fit the description of characters that should be substituted;
outputting the display string to a display of a user device;
detecting a requested change to the display string, the requested change entered by a user at the user device;
updating the raw string to reflect the detected requested change;
passing to the character substitution binding the updated raw string;
receiving, from the character substitution binding, an updated substituted display string that includes the character to be used for substitution in place of any characters in the updated raw string that fit the description of characters that should be substituted;
outputting the substituted display string to the display of the user device; and
outputting the updated raw string, as a value of a variable, to a computer program.

2. The method of claim 1, further comprising detecting additional requested changes to the display string, wherein the updating, passing the updated raw string to the character substitution binding, and receiving an updated substituted display string are repeated for each additional requested change that is detected.

3. The method of claim 1, wherein the characters that should be substituted are non-displayable control characters.

4. The method of claim 1, wherein the requested change includes overwriting a value of one or more of the characters in the raw string.

5. The method of claim 1, wherein the requested change includes an edit selected from the group consisting of deleting a character in the raw string and inserting a character into the raw string.

6. The method of claim 1, wherein the requested change includes an edit selected from the group consisting of deleting a plurality of characters in the raw string and inserting a plurality of characters into the raw string.

7. The method of claim 1, wherein a different character is used for substitution for at least two of the characters that should be substituted.

8. A system comprising:
a memory having computer readable instructions; and
a processor for executing the computer readable instructions, the computer readable instructions including:
initializing a character substitution binding by passing to the character substitution binding an un-substituted raw string, a description of characters that should be substituted, and a character to be used for substitution;
receiving, from the character substitution binding, a new substituted display string that includes the character to be used for substitution in place of any characters in the raw string that fit the description of characters that should be substituted;
outputting the display string to a display of a user device;
detecting a requested change to the display string, the requested change entered by a user at the user device;
updating the raw string to reflect the detected requested change;
passing to the character substitution binding the updated raw string;
receiving, from the character substitution binding, an updated substituted display string that includes the character to be used for substitution in place of any characters in the updated raw string that fit the description of characters that should be substituted;
outputting the substituted display string to the display of the user device; and
outputting the updated raw string, as a value of a variable, to a computer program.

9. The system of claim 8, wherein the computer readable instructions further include detecting additional requested changes to the display string, wherein the updating, passing the updated raw string to the character substitution binding, and receiving an updated substituted display string are repeated for each additional requested change that is detected.

10. The system of claim 8, wherein the characters that should be substituted are non-displayable control characters.

11. The system of claim 8, wherein the requested change includes overwriting a value of one or more of the characters in the raw string.

12. The system of claim 8, wherein the requested change includes an edit selected from the group consisting of deleting a character in the raw string and inserting a character into the raw string.

13. The system of claim 8, wherein the requested change includes an edit selected from the group consisting of deleting a plurality of characters in the raw string and inserting a plurality of characters into the raw string.

14. The system of claim 8, wherein a different character is used for substitution for at least two of the characters that should be substituted.

15. A computer program product comprising a computer readable storage medium having program instructions embodied therewith, the program instructions executable by processing circuitry to cause the processing circuitry to perform:
initializing a character substitution binding by passing to the character substitution binding an un-substituted raw string, a description of characters that should be substituted, and a character to be used for substitution;
receiving, from the character substitution binding, a new substituted display string that includes the character to be used for substitution in place of any characters in the raw string that fit the description of characters that should be substituted;
outputting the display string to a display of a user device;
detecting a requested change to the display string, the requested change entered by a user at the user device;
updating the raw string to reflect the detected requested change;
passing to the character substitution binding the updated raw string;
receiving, from the character substitution binding, an updated substituted display string that includes the character to be used for substitution in place of any characters in the updated raw string that fit the description of characters that should be substituted;
outputting the substituted display string to the display of the user device; and
outputting the updated raw string, as a value of a variable, to a computer program.

16. The computer program product of claim 15, wherein the program instructions executable by processing circuitry further cause the processing circuitry to perform detecting additional requested changes to the display string, wherein the updating, passing the updated raw string to the character substitution binding, and receiving an updated substituted display string are repeated for each additional requested change that is detected.

17. The computer program product of claim 15, wherein the characters that should be substituted are non-displayable control characters.

18. The computer program product of claim 15, wherein the requested change includes overwriting a value of one or more of the characters in the raw string.

19. The computer program product of claim 15, wherein the requested change includes an edit selected from the group consisting of deleting a character in the raw string and inserting a character into the raw string.

20. The computer program product of claim 15, wherein the requested change includes an edit selected from the group consisting of deleting a plurality of characters in the raw string and inserting a plurality of characters into the raw string.
